(19) United States
(12) Patent Application Publication
(10) Pub. No.: US 2016/0160742 A1
(43) Pub. Date: Jun. 9, 2016

(54) ENGINE SYSTEM HAVING ENRICHED PRE-CHAMBER SPARK PLUG

(71) Applicant: Caterpillar Inc., Peoria, IL (US)

(72) Inventors: Martin Leo WILLI, Dunlap, IL (US); David Mark GINTER, Commerce Township, MI (US); Daniel George VAN ALSTINE, Dunlap, IL (US)

(73) Assignee: Caterpillar Inc., Peoria, IL (US)

(21) Appl. No.: 14/559,890

(22) Filed: Dec. 3, 2014

(51) Int. Cl. F02B 19/10; F02D 41/24; F02B 19/12; F02D 41/30; F02P 15/00; F02F 1/24

(52) U.S. Cl. CPC F02B 19/1085; F02P 15/006; F02F 1/242; F02B 19/1004; F02B 19/12; F02D 41/3005; F02D 41/2406

(57) ABSTRACT

A spark plug arrangement is disclosed for use in an engine system. The spark plug arrangement may include a body, and a cap fixedly connected to the body to form an integral pre-chamber. The cap may have at least one orifice. The spark plug arrangement may also include an electrode extending through the body and at least partially into the pre-chamber. The electrode may be configured to create a spark in the pre-chamber. The spark plug arrangement may further include a capillary tube disposed within the body and configured to inject gaseous fuel into the pre-chamber to form an air and fuel mixture to be ignited by the spark in the pre-chamber.

### TECHNICAL FIELD

The present disclosure relates generally to an engine system and, more particularly, to an engine system having an enriched pre-chamber spark plug.

### BACKGROUND

The desire to provide high engine efficiency with low emissions has resulted in an increased emphasis on the use of fuels that are readily available and that are clean burning. Natural gas is an abundant, clean burning fuel with improved emission levels of both nitrogen oxides and particulate matter. The conversion of diesel engines, which inherently have high efficiency as a result of high compression ratios, into natural gas operation for improved emissions levels has been an aspiration of the internal combustion engine industry for a period of time.

A technique for converting diesel engines to natural gas operation is known as High Pressure Direct Injection (HPDI). Typical HPDI gas engines burn a large percentage of gaseous fuel, yielding an improvement over diesel engines with respect to the emission levels. In addition, HPDI gas engines purport to achieve the same combustion efficiency, power output, and torque output as state-of-the-art diesel engines. The operational principle underlying typical HPDI gas engines is that two fuels are injected under pressure into the combustion chamber near the end of the compression stroke. According to one method, a small quantity of “pilot fuel” (typically diesel) is injected into the cylinder immediately followed by a more substantial quantity of gaseous natural gas. The pilot fuel readily ignites at the pressure and temperature within the cylinder at the end of the compression stroke, and the combustion of the pilot fuel initiates the combustion of the natural gas that might otherwise he difficult to ignite.

One example of a HPDI gas engine is disclosed in U.S. Pat. No. 8,555,852 of Munshi et al. that issued on Oct. 15, 2013 (“the '852 patent”). In particular, the '852 patent discloses a compression ignition engine having a primary fuel injector and a pilot fuel injector both mounted in a cylinder head of the engine. The primary fuel injector and the pilot fuel injector are each partially exposed to a combustion chamber of the engine. The primary fuel injector supplies gaseous fuel directly into a combustion chamber of an engine at a high pressure, while the pilot fuel injector supplies a small amount of diesel fuel into the combustion chamber to ignite the gaseous fuel.

Although the HPDI gas engine of the '852 patent may be adequate for some applications, it may still be less than optimal. In particular, using two or more fuels may be overly complex and costly. In addition, the use of diesel fuel in the HPDI gas engine of the '852 patent, while limited, can still produce higher emissions. It is therefore desirable to operate a HPDI gas engine using only gaseous fuel.

The engine system of the present disclosure solves one or more of the problems set forth above and/or other problems in the art.

### SUMMARY

In one aspect, the present disclosure is directed to a spark plug arrangement. The spark plug arrangement may include a body, and a cap fixedly connected to the body to form an integral pre-chamber. The cap may have at least one orifice. The spark plug arrangement may also include an electrode extending through the body and at least partially into the pre-chamber. The electrode may be configured to create a spark in the pre-chamber. The spark plug arrangement may further include a capillary tube disposed within the body and configured to inject gaseous fuel into the pre-chamber to form an air and fuel mixture to be ignited by the spark in the pre-chamber.

In another aspect, the present disclosure is directed to a method of operating an engine system. The method may include injecting gaseous fuel into a pre-chamber of a spark plug, igniting the gaseous fuel within the pre-chamber of the spark plug, and directing a plurality of flame jets from the pre-chamber of the spark plug to a combustion chamber. The method may further include injecting gaseous fuel into the combustion chamber to intersect with the plurality of flame jets, and igniting the gaseous fuel within the combustion chamber.

In yet another aspect, the present disclosure is directed to an engine system. The engine system may include an engine block at least partially defining a plurality of cylinders, and a plurality of pistons each disposed within one of the plurality of cylinders. The engine system may also include a plurality of cylinder heads each configured to engage the engine block and close off one or more of the plurality of cylinders to form a plurality of combustion chambers. The engine system may further include a plurality of gaseous fuel injectors disposed within the plurality of cylinder heads, and a plurality of pre-chamber spark plugs disposed within the plurality of cylinder heads. Each pre-chamber spark plug may have a body, and a cap fixedly connected to the body to form an integral pre-chamber. The cap may have a plurality of orifices. Each pre-chamber spark plug may also have an electrode extending through the body and at least partially into the pre-chamber. The electrode may be configured to create a spark in the pre-chamber. Each pre-chamber spark plug may further have a capillary tube disposed within the body and configured to inject gaseous fuel into the pre-chamber to form an air and fuel mixture to be ignited by the spark in the pre-chamber. The engine system may additionally include a supply of gaseous fuel in communication with the plurality of gaseous fuel injectors and the plurality of pre-chamber spark plugs.

### BRIEF DESCRIPTION OF THE DRAWINGS

FIG. 1 is a cross-sectional illustration of an exemplary disclosed engine system;

FIG. 2 is a cross-sectional illustration of an exemplary disclosed cylinder head assembly that may be used in conjunction with the engine system of FIGS. 1; and

FIG. 3 is a flowchart depicting an exemplary disclosed method that may be performed by the engine system of FIG. 1.

### DETAILED DESCRIPTION

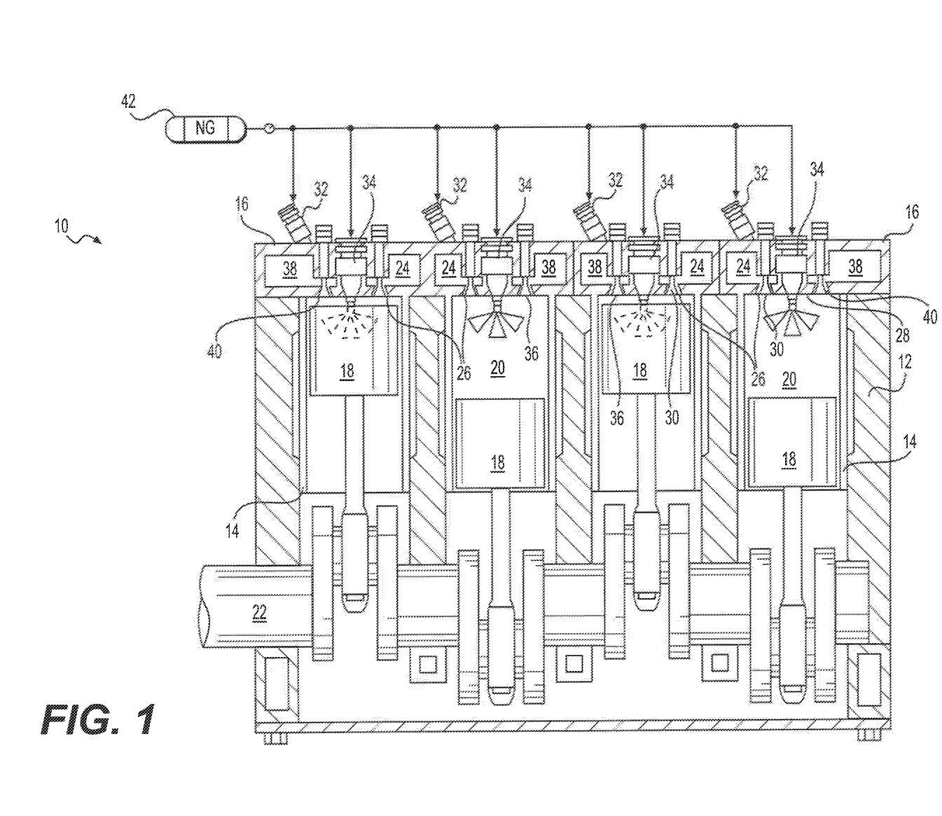

FIG. 1 illustrates an exemplary engine system. 10. In the disclosed embodiment, engine system 10 is a High Pressure Direct Injection (HPDI) gas engine system. Engine system 10 may include, among other things, an engine block 12 defining a plurality of cylinders 14. A cylinder head 16 may be connected to engine block 12 to close off an end of each cylinder 14, and a piston 18 may be slidably disposed within cylinder 14. Piston 18, together with cylinder 14 and cylinder head 16, may define a combustion chamber 20. It is contemplated that engine system 10 may include any number of combustion chambers 20 and that combustion chambers 20 may be disposed in an “in-line” configuration, in a “V” configuration, in an opposing-piston configuration, or in any other suitable configuration.

Piston 18 may be configured to reciprocate within cylinder 14 between a top-dead-center position (TDC) and a bottom-dead-center position (BDC). In particular, piston 18 may be pivotally connected to a crankshaft 22, which is rotatably disposed within engine block 12. In this configuration, a sliding motion of each piston 18 within a corresponding cylinder 14 may result in a rotation of crankshaft 22. Similarly, a rotation of crankshaft 22 may result in the sliding motion of piston 18. As crankshaft 22 rotates through about 720°, each piston 18 may move through four different strokes. Specifically, engine system 10 (as a four-stroke engine) may undergo a complete combustion cycle that includes an intake stroke (TDC to BDC), a compression stroke (BDC to TDC), a power stroke (TDC to BDC), and an exhaust stroke (BDC to TDC).

During the intake stroke, air may be drawn and/or forced into combustion chamber 20 from an intake manifold 24 via one or more intake ports 26 located within cylinder head 16 (e.g., located within a fire deck 28 of cylinder head 16). In particular, as piston 1$ moves downward within cylinder 14 toward BDC, one or more gas exchange valves (e.g., intake valves) 30 associated with intake ports 26 may be caused to move and open intake ports 26. When intake ports 26 are open and a pressure of air within intake manifold 24 is greater than a pressure within combustion chamber 20, air should pass through intake ports 26 into combustion chamber 20.

Gaseous fuel (e.g., natural gas) may be mixed with the air after the air enters combustion chamber 20. In the disclosed embodiment, engine system 10 may run on gaseous fuel alone. For example, a gaseous fuel injector 34 is generally centrally mounted within each cylinder head 16 to inject gaseous fuel into combustion chamber 20. In addition, a pre-chamber spark plug 32 may also be mounted within each cylinder head 16 to ignite a mixture of air fuel within combustion chamber 20.

During the compression stroke, piston 18 starts its upward stroke and intake ports 26 are gradually blocked by motion of intake valves 30. At a predetermined timing, spark plug 32 may direct flame jets into combustion chamber 20. Gaseous fuel from injector 34 may be injected and mix with the air from intake ports 26 to form a fuel/air mixture within combustion chamber 20. The flame jets from spark plug 32 will intersect with the mixture and cause the mixture to combust and release chemical energy. This may result in a further and significant increase in the pressure and temperature within combustion chamber 20.

The increased pressure caused by combustion may force piston 18 back downward, thereby imparting mechanical power to crankshaft 22 during the power stroke. Then during the ensuing exhaust stroke, one or more gas exchange valves (e.g., exhaust valves) 36 located within cylinder head 16 may open to allow pressurized exhaust within combustion chamber 20 to exit into an associated exhaust manifold 38 via corresponding exhaust ports 40. In particular, as piston 18 moves upward within cylinder 16, a position will eventually be reached at which one or more gas exchange valves (e.g., exhaust valves) 36 move to fluidly communicate combustion chamber 20 with exhaust manifold 38 by way of ports 40. When combustion chamber 20 is in fluid communication with exhaust manifold 38 and a pressure in combustion chamber 20 is greater than a pressure in exhaust manifold 38, exhaust should pass from combustion chamber 20 through exhaust ports 40 into exhaust manifold 38.

In the disclosed embodiment, movement of intake and exhaust valves 30, 36 may be cyclically controlled, for example by way of an overhead cam (not shown), rocker arm (not shown), and/or other device that is mounted to or above cylinder head 16 and mechanically driven by crankshaft 22. It is contemplated, however, that movement of intake and/or exhaust valves 30, 36 may alternatively be controlled in a non-cyclical manner, if desired. It is also contemplated that intake and/or exhaust ports 26, 40 could alternatively be located within an annular wall of cylinder 14, with their openings and closings dictated by the motion of piston 18. Although operation of a four-stroke engine has been described with reference to FIG. 1, one skilled in the art would understand that gaseous fuel may be combusted and exhaust may be generated in a similar manner in a two-stroke engine.

The gaseous fuel sprayed by injectors 34 into combustion chambers 20 may be provided from a supply 42. Supply 42 may embody, for example, a high-pressure cryogenic tank configured to hold liquid fuel (e.g., liquefied natural gas—LNG) at low temperatures. The liquid fuel may be vaporized prior to entering injectors 34. It is contemplated that, in other embodiments, supply 42 may hold any other gaseous fuel known in the art, for example, compressed natural gas. In some applications, a heater, accumulator, and/or pressure regulator may be used to vaporize, contain, and circulate the fuel. In addition to gaseous fuel being directed to injectors 34, gaseous fuel may also be provided to spark plug 32 to assist with ignition, as will be described in more detail below.

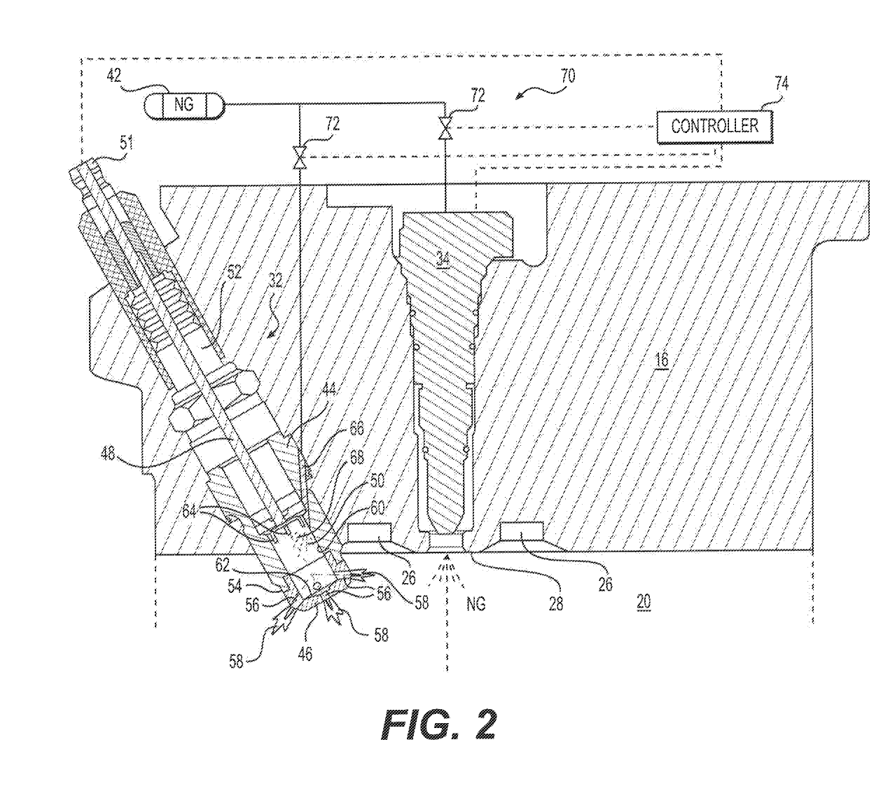

FIG. 2 illustrates an exemplary cylinder head assembly having spark plug 32 and injector 34 mounted within cylinder head 16. As shown in Fig, 2, injector 34 may be generally centrally located (e.g., aligned with a central axis of cylinder 14), while spark plug 32 may be located at a periphery of fire deck 28 and extend to a location between two valve ports (e.g., one intake port 26 and one adjacent exhaust port 40). Injector 34 may be completely mounted inside a recess of cylinder head 16 and oriented vertically, while spark plug 32 may also be mounted inside of cylinder head 16 and oriented at an oblique angle. It is contemplated, however, that, in some embodiments, spark plug 32 may instead be oriented vertically adjacent to injector 34. It is further contemplated that, in other embodiments, spark plug 32 and injector 34 may be packaged together in a single arrangement, either concentrically or adjacent to one another. Injector 34 may inject gaseous fuel into combustion chamber 20, while spark plug 32 may direct flame jets, such that the gaseous fuel injection intersects with the flame jets in combustion chamber 20.

As shown in FIG. 2, spark plug 32 may include multiple components that cooperate to ignite the air and fuel mixture within combustion chamber 20. In particular, spark plug 32 may include a body 44, a cap 46, and at least one electrode 48. Body 44 may be generally hollow at one end and, together with cap 46, may at least partially form an integral pre-chamber 50 (also known as a pre-chamber). Electrode 48 may extend from a terminal end 51 of spark plug 32 through body 44 and at least partially into pre-chamber 50. In one embodiment, an insulator 52 may be disposed between body 44 and electrode 48 to electrically isolate electrode 48 from body 44.

Body 44 may be a generally cylindrical structure fabricated from an electrically conductive material. In one embodiment, body 44 may include external threads (not shown) configured for direct engagement with engine block 12 or with cylinder head 16 to cap off combustion chamber 20. In this configuration, body 44 may be electrically grounded via a connection with engine block 12 or cylinder head 16.

Cap 46 may have a cup-like shape and be fixedly connected to an end 54 of body 44. Cap 46 may be welded, press-fitted, threadingly engaged, or otherwise fixedly connected to body 44. Cap 46 may include a plurality of orifices 56 that facilitate the passage of flame jets 58 from pre-chamber 50 into combustion chamber 20 of engine block 12. Orifices 56 may pass generally radially through an annular side wall 60 of cap 46 and/or through an end wall 62 of cap 46.

Electrode 48 may be fabricated from an electrically conductive metal such as, for example, tungsten, iridium, silver, platinum, and gold palladium, and be configured to direct current from, for example, a RF power supply (not shown) to ionize (i.e., create a corona within) and ignite the air and fuel mixture in pre-chamber 50. In one embodiment, a plurality of prongs 64 may extend generally radially toward an internal wall of pre-chamber 50, such that sparks may be created between electrode 48 and the internal wall of pre-chamber 50.

Typical pre-chamber spark plugs are used in engines operating with a mixture of fuel and air in the combustion chamber prior to or during the compression stroke. The orifices of the spark plug facilitate the flow of the mixture into the pre-chamber, where the electrode ignites the mixture. The ignition causes flame jets to be emitted through the orifices to ignite the rest of the mixture of fuel and air within the combustion chamber. In HPDI applications, however, the mixture of fuel and air is not initially present within the combustion chamber prior to or during the compression stroke. Instead, the combustion chamber contains only air. Thus, if typical pre-chamber spark plugs were used in HPDI applications, combustion could not occur in the pre-chamber.

In order to account for these difficulties, the disclosed spark plug 32 may be enriched with an injection of gaseous fuel to facilitate ignition in pre-chamber 50. Specifically, a fuel system 70 may be provided to selectively direct gaseous fuel to spark plug 32. For example, fuel system 70 may include a first control valve 72 and a controller 74 configured to regulate a flow of gaseous fuel from supply 42 to a capillary tube 66 disposed within body 44 of spark plug 32. Capillary tube 66 may be configured to provide a passage for gaseous fuel 68 to be injected into pre-chamber 50. In some applications, the injection of gaseous fuel may cause an air-fuel excess air ratio (2) to decrease from a substantially high value (i.e., no fuel present in pre-chamber 50) to a value of about 0.8 to 2.0 (i,e., closer to stoichiometric values). In other words, the air-fuel excess air ratio prior to the injection of gaseous fuel 68 into pre-chamber 50 is substantially higher than the air-fuel excess air ratio after the injection of gaseous fuel 68 into pre-chamber 50. This decrease in air-fuel excess air ratio may allow gaseous fuel 68 to be ignited inside pre-chamber 50 and flame jets 58 to be directed into combustion chamber 20 via orifices 56. Fuel system 70 may also regulate a flow of gaseous fuel from supply 42 to injector 34 via a second control valve 72. Although not shown in FIG. 2, the second control valve 72 may be located inside injector 34. In some embodiments, controller 74 may control one or more operations of spark plug 32, injector 34, and/or valves 72.

In some embodiments, pre-chamber 50 may have a volume that is about 0.2% to 1.0% of a volume of combustion chamber 20 while piston 18 is at TDC. In one embodiment, the volume of pre-chamber 50 may be about 0.3% of the volume of combustion chamber 20 while piston 18 is at TDC. This particular pre-chamber volume may provide a sufficient ignition source for combustion chamber 20, without requiring large amounts of packaging space in cylinder head 16, 00291 Controller 74 may embody a single or multiple microprocessors, field programmable gate arrays (FPGAs), digital signal processors (DSPs), etc., that is configured to control one or more aspects of the operation of engine system 10. For example, controller 74 may be programmed to control spark plug 32, injector 34, and/or valves 72. Controller 74 may control spark plug 32, injector 34, and/or valves 72 by transmitting signals, such as, for example, currents, to control spark plug 32, injector 34, and/or valves 72. The transmitted signals may result in actuation of spark plug 32, injector 34, and/or valves 72. In some embodiments, controller 74 may control spark plug 32, injector 34, and/or valves 72 based on current operating conditions of engine system 10, one or more maps relating to fuel system parameters stored in the memory of controller 74 (e.g., fuel injection timings), and/or information received from one or more sensors (not shown) strategically located throughout engine system 10. Numerous commercially available microprocessors can be configured to perform the functions of these components. Various known circuits may be associated with these components, including power supply circuitry, signal-conditioning circuitry, actuator driver circuitry (i.e., circuitry powering solenoids, motors, or piezo actuators), and communication circuitry.

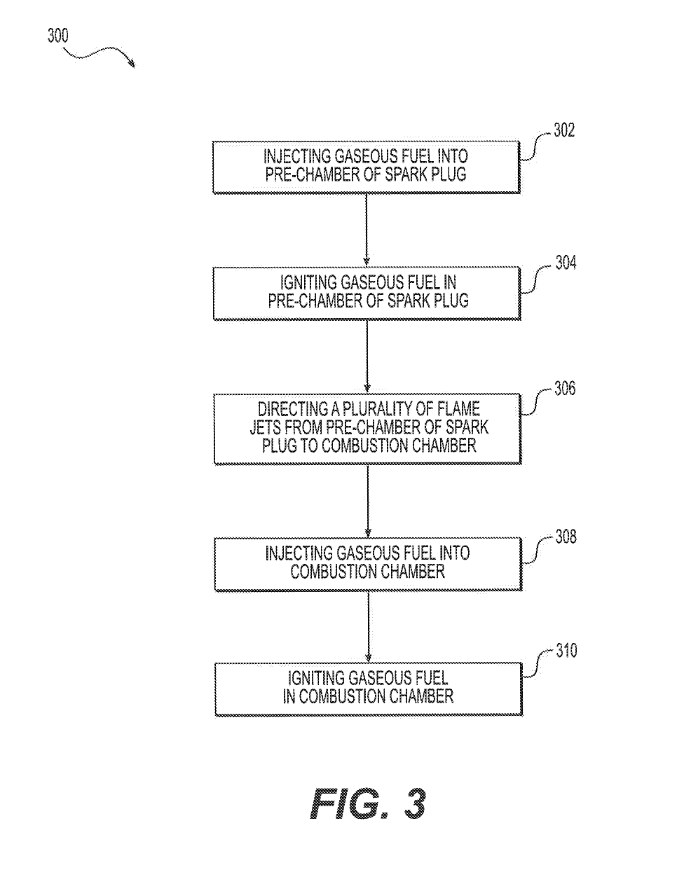

FIG. 3 is a flowchart depicting an exemplary disclosed method 300 that may be performed by the system of FIGS. 1 and 2. FIG. 3 will be discussed in more detail below to further illustrate the disclosed concepts.

### INDUSTRIAL APPLICABILITY

The disclosed engine system may be used in any machine or power system application with particular applicability in engine systems utilizing HPDI. The disclosed engine system may run on gaseous fuel alone, while still achieving performance similar to the performance of diesel fueled engines. The use of 100% gaseous fuel may produce lower levels of regulated exhaust constituents as well as provide cost reduction compared to systems running at least partially on diesel fuel. Additionally, the disclosed engine system may decrease complexity by running on a single fuel. Operation of engine system 10 will now be explained in detail,

During operation of engine system 10, gaseous fuel may be supplied to spark plug 32 and injector 34 from supply 42 (referring to FIG. 1). For example, liquefied natural gas may be vaporized, and directed in parallel through first and second valves 72 to deliver fuel to capillary tube 66 and a gas inlet of injector 34, respectively.

Referring to FIG. 3, at step 302, gaseous fuel may be injected into pre-chamber 50 of spark plug 32. For example, controller 74 may cause first valve 72 to move to a flow-passing position, such that gaseous fuel is drawn from supply 42 and directed through capillary tube 66 into pre chamber 50. In some applications, controller 74 may actuate valve 72 based on current operating conditions of engine system 10, one or more maps relating to fuel system parameters stored in the memory of controller 74 (e.g., fuel injection timings), and/or information received from one or more sensors (not shown) strategically located throughout engine system 10. After the injection of gaseous fuel into pre-chamber 50, the air-fuel excess air ratio of pre-chamber 50 may be decreased from a substantially high value to a value of about 0.8 to 2.0.

At step 304, the gaseous fuel within pre-chamber 50 may be ignited. Specifically, controller 74 may cause electrode 48 to direct current from the RF power supply to ignite the air and fuel mixture of pre-chamber 50. In some applications, controller 74 may actuate electrode 48 based on current operating conditions of engine system 10, one or more maps relating to fuel system parameters stored in the memory of controller 74 (e.g., fuel injection timings), and/or information received from one or more sensors (not shown) strategically located throughout engine system 10. At step 306, the ignition may cause flame jets 58 to be emitted from pre-chamber 50 into combustion chamber 20 via orifices 56.

At step 308, either before or after the emission of flame jets 58, gaseous fuel may be injected into combustion chamber 20 via injector 34. More specifically, controller 74 may cause second valve 72 to move to a flow-passing position, such that gaseous fuel is drawn from supply 42 and directed to injector 34. Gaseous fuel may be injected at an increased pressure from injector 34 to intersect with flame jets 58. Depending on a predetermined timing sequence, the gaseous fuel may be injected before or after the emission of flame jets 58. In some applications, controller 74 may directly control injector 34 based on current operating conditions of engine system 10, one or more maps relating to fuel system parameters stored in the memory of controller 74 (e.g., fuel injection timings), and/or information received from one or more sensors (not shown) strategically located throughout engine system 10. At step 310, the gaseous fuel in combustion chamber 20 may be ignited. Specifically, the gaseous fuel may mix with the air from intake ports 26, and the mixture may then be ignited by the intersecting flame jets 58.

Because the disclosed engine system operates only on gaseous fuel, the engine system may be relatively less complex and inexpensive. In particular, the use of an enriched pre-chamber spark plug may replace a need for a shot of diesel fuel in HPDI gas engines. As a result, operators will not be required to maintain and provide equipment for multiple fuel sources. Additionally, the disclosed engine system may achieve similar performance as dual fuel engines, while achieving lower levels of regulated exhaust constituents and providing fuel cost savings.

It will be apparent to those skilled in the art that various modifications and variations can be made to the disclosed engine systems without departing from the scope of the disclosure. Other embodiments of the engine systems will he apparent to those skilled in the art from consideration of the specification and practice of the engine systems disclosed herein. It is intended that the specification and examples be considered as exemplary only, with a true scope of the disclosure being indicated by the following claims and their equivalents.

1. A spark plug arrangement, comprising:
a body;
a cap fixedly connected to the body to form an integral pre-chamber, the cap having at least one orifice;
an electrode extending through the body and at least partially into the pre-chamber, the electrode configured to create a spark in the pre-chamber; and
a capillary tube disposed within the body and configured to inject gaseous fuel into the pre-chamber to form an air and fuel mixture to be ignited by the spark in the pre-chamber.

2. The spark plug arrangement of claim 1, further including a control valve configured to regulate a flow of gaseous fuel from a supply of gaseous fuel to the capillary tube.

3. The spark plug arrangement of claim 2, further including a controller configured to selectively actuate the control valve based on at least one of a current operating condition of an engine system and one or more maps relating to fuel system parameters stored in a memory of the controller.

4. The spark plug arrangement of claim 1, wherein the air and fuel mixture in the pre-chamber has an air-fuel excess air ratio of about 0.8 to 2.0.

5. The spark plug arrangement of claim 1, wherein an air-fuel excess air ratio prior to injection of gaseous fuel into the pre-chamber is higher than an air-fuel excess air ratio after the injection of gaseous fuel.

6. The spark plug arrangement of claim 1, wherein the gaseous fuel is liquefied natural gas that is vaporized prior to entering the capillary tube.

7. The spark plug arrangement of claim 1, wherein the gaseous fuel is compressed natural gas.

8. The spark plug arrangement of claim 1, wherein the at least one orifice includes a plurality of orifices extending through the cap.

9. The spark plug arrangement of claim 8, wherein a plurality of flame jets resulting from ignition of the air and fuel mixture pass from the pre-chamber through the plurality of orifices.

10. The spark plug arrangement of claim 1, the electrode includes a plurality of prongs extending radially toward an annular wall of the pre-chamber.

11. A method of operating an engine system, comprising:
injecting gaseous fuel into a pre-chamber of a spark plug through a capillary tube;
igniting the gaseous fuel within the pre-chamber of the spark plug;
directing a plurality of flame jets from the pre-chamber of the spark plug to a combustion chamber;
injecting gaseous fuel into the combustion chamber to intersect with the plurality of flame jets; and
igniting the gaseous fuel within the combustion chamber.

12. The method of claim 11, further including selectively directing gaseous fuel to the pre-chamber of the spark plug through e the capillary tube via a control valve.

13. The method of claim 11, further including decreasing an air-fuel excess air ratio within the pre-chamber of the spark plug to about 0.8 to 2.0.

14. The method of claim 11, wherein an air-fuel excess air ratio prior to injecting the gaseous fuel into the pre-chamber of the spark plug is higher than an air-fuel excess air ratio after injecting the gaseous fuel into the pre-chamber of the spark plug.

15. The method of claim 11, wherein igniting the gaseous fuel within the pre-chamber of the spark plug includes creating a spark in the pre-chamber of the spark plug via an electrode.

16. The method of claim 11, wherein the gaseous fuel is injected into the combustion chamber after the plurality of flame jets are directed into the combustion chamber.

17. The method of claim 11, wherein the gaseous fuel is injected into the combustion chamber before the plurality of flame jets are directed into the combustion chamber.

18. An engine system, comprising:
an engine block at least partially defining a plurality of cylinders;
a plurality of pistons, each disposed within one of the plurality of cylinders;
a plurality of cylinder heads, each configured to engage the engine block and close off one or more of the plurality of cylinders to form a plurality of combustion chambers;
a plurality of gaseous fuel injectors disposed within the plurality of cylinder heads;
a plurality of pre-chamber spark plugs disposed within the plurality of cylinder heads, each having:
a body;
a cap fixedly connected to the body to form an integral pre-chamber, the cap having a plurality of orifices;
an electrode extending through the body and at least partially into the pre-chamber, the electrode configured to create a spark in the pre-chamber; and
a capillary tube disposed within the body and configured to inject gaseous fuel into the pre-chamber to form an air and fuel mixture to be ignited by the spark in the pre-chamber; and
a supply of gaseous fuel in communication with the plurality of gaseous fuel injectors and the plurality of pre-chamber spark plugs.

19. The engine system of claim 18, further including at least one control valve configured to regulate a flow of gaseous fuel from the supply of gaseous fuel to each capillary tube,

20. The engine system of claim 19, further including a controller configured to selectively actuate the at least one control valve based on at least one of a current operating condition of the engine system and one or more maps relating to fuel system parameters stored in a memory of the controller.
